(19) United States
(12) Patent Application Publication
(10) Pub. No.: US 2007/0114394 A1
(43) Pub. Date: May 24, 2007

(54) Method and system for determining and quantifying specific trace elements in samples of complex materials

(76) Inventors: Gerald Combs, Bartlesville, OK (US); Dean Vinson Davis, Bartlesville, OK (US); Hartmut Oesten, Durmersheim (DE); Michael Przybylski, Konstanz (DE); Wayne Vincent Rimkus, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/255,277

(22) Filed: Oct. 21, 2005

(51) Int. Cl. H01J 49/00

(52) U.S. Cl. 250/292

(57) ABSTRACT

A system for determining and quantifying specific trace elements in samples of complex materials has a laser ablation (LA) apparatus (1) coupled to a Fourier transform ion cyclotron resonance mass spectrometer (FT-ICR-MS) (2) with a mass range of at least 2 to 300 amu and a mass resolution of at least 8000 for 300 amu.

### TECHNICAL FIELD

The invention relates to a method and a system for determining and quantifying specific trace elements in samples of complex materials. It should be appreciated that the term elements also includes their ions and isotopes.

### BACKGROUND

The specific element analysis in complex materials, such as biological materials, geological and environmental samples, has recently found high interest in biochemical and biotechnological applications, development of advanced environmental technology, geotechnology and in biomedical diagnostics. Examples are determinations of specific elements of modified protein structures, such as phosphorous and sulfur in proteomics (analysis of proteins), transition and heavy metals in geological and environmental analysis procedures, and of biological and exogenous metals in toxicological analyses.

In a number of recent applications, a combination of laser ablation (LA) or thermal sample desorption, element inductively coupled plasma (ICP) ionization and element mass spectrometry (MS) has been used. For example, in biochemical applications to proteome (complete set of proteins present in a cell or organism) analysis, proteins separated by gel electrophoresis, e.g. from cell lysate, are sampled directly from protein spots using laser ablation. The sample material is vaporized or nebulized by the focused laser radiation and transported with argon into the inductively coupled plasma ion source of an inductively coupled plasma mass spectrometer (ICP-MS). The resulting ions are passed through an interface into the high vacuum of the mass spectrometer and are there separated and then detected according to their mass to charge ratio (e.g. Becker, J. S. et al.: “Determination of phosphorus and metals in human brain proteins after isolation by gel electrophoresis by laser ablation inductively coupled plasma source mass spectrometry” in Journal of Analytical Atomic Spectrometry, 2004, 19(1), 149-152).

Quadrupole mass spectrometers have been used in ICP-MS for some time, but the use of magnetic sector mass spectrometers has become more common because of their higher resolution.

Major current problems of direct element analysis from complex materials such as element proteomics or metallomics (similar to proteomics, but dealing with metal concentrations and especially with their binding to proteins and other molecules) are interferences from background elements such as phosphorous in biological materials, as well as insufficient separation of element and isotopic masses and insufficient resolution for specific element identification.

Quadrupole mass spectrometers have resolutions sufficient for most routine applications but not sufficient for specific element analysis. Magnetic sector mass spectrometers, which have become more common in ICP-MS, can provide a higher mass resolution, which allows the user to separate overlapping molecular or isobaric interferences from the elemental isotopes of interest. However, apart from the fact that magnetic sector mass spectrometers are very expensive, their mass resolution is still not sufficient for many applications that require single isotope resolution, especially when the masses of isotopes of different elements coincide.

Therefore, exact element quantifications are often severely hampered in present analyses, in most cases by overlap of metal ions from biological or chemical background.

Fourier transform ion cyclotron resonance mass spectrometry (FT-ICR-MS) has received considerable attention for its ability to make mass measurements with a combination of resolution and accuracy that is higher than any other mass spectrometer. At the present state of technological development and application, FT-ICR-MS instruments in the field of bioanalysis, proteomics and analysis of other complex mixtures have entirely focused on applications on biomolecular analysis using appropriate specific ionization procedures such as electrospray ionization (ESI) and matrix-assisted laser desorption ionization (MALDI). In MALDI, a laser is used to desorb sample molecules from a solid or liquid matrix containing a highly UV-absorbing substance. In ESI, highly charged droplets dispersed from a capillary in an electric field are evaporated and produced ions are drawn into the mass spectrometer. The advantage of ESI and MALDI is their ability to ionize large biomolecules such as peptides and proteins, which makes ESI- and MALDI-FT-ICR-MS especially useful for sophisticated biomedical analysis.

An example of a Fourier transform ion cyclotron resonance mass spectrometer (FT-ICR-MS) is shown in U.S. Pat. No. 6,822,223 (Davis) titled “Method, system and device for performing quantitative analysis using a FMTS”, the disclosure of which is hereby incorporated as reference. The known FT-ICR-MS comprises a trapped ion cell contained within an evacuated chamber and permeated by a homogeneous static magnetic field. The sample to be analyzed is admitted to the vacuum chamber and the trapped ion cell between the magnetic poles and thus across the magnetic field. Within the trapped ion cell, the sampled molecules can be automatically converted to charged ions by a gated electron beam passing through the trapped ion cell or other appropriate ionization techniques. U.S. Pat. No. 6,822,223 cites a photon source, chemical ionizer, negative ionizer, electron ionization (EI), electrospray ionization (ESI), MALDI, atmospheric pressure chemical ionization (APCI), fast atom bombardment (FAB) and ICP. Alternatively, the sample molecules can be created external to the vacuum chamber by any one of many different techniques and then injected along the magnetic field axis into the chamber and trapped ion cell.

It is an object of the invention to allow for determining and quantifying specific trace elements in samples of complex materials with high resolution.

### SUMMARY

According to the invention this object can be achieved by a laser ablation Fourier transform ion cyclotron resonance mass spectrometer (LA-FT-ICR-MS) for trace element analysis, said spectrometer having a mass range of at least 2 to 300 amu and a mass resolution of at least 8000 for 300 amu.

The object can also be achieved by a system for determining and quantifying specific trace elements in samples of complex materials, said system comprising a laser ablation apparatus coupled to a Fourier transform ion cyclotron resonance mass spectrometer (FT-ICR-MS) having a mass range of at least 2 to 300 amu and a mass resolution of at least 8000 for 300 amu.

The FT-ICR-MS may comprise a trapped ion cell contained within an evacuated chamber and a magnet system for providing and passing a homogeneous static magnetic field through the trapped ion cell, wherein the samples from the laser ablation apparatus being admitted to the evacuated chamber and the trapped ion cell along a path between the magnetic poles and ionized by an electron beam passing through the trapped ion cell. The laser ablation apparatus can be coupled to the FT-ICR-MS via a inductively coupled plasma ion source and the FT-ICR-MS may comprise a trapped ion cell contained within an evacuated chamber and a magnet system for providing and passing a homogeneous static magnetic field through the trapped ion cell, the samples coming from the ICP ion source being injected into the chamber and trapped ion cell along the magnetic field axis.

The object can also be achieved by a method for determining and quantifying specific trace elements in samples of complex materials, comprising the steps of: sampling a material by means of laser ablation and introducing said samples into a Fourier transform ion cyclotron resonance mass spectrometer (FT-ICR-MS) having a mass range of at least 2 to 300 amu and a mass resolution of at least 8000 for 300 amu.

The method may further comprise the steps of: passing a homogeneous static magnetic field through an evacuated chamber of the FT-ICR-MS containing a trapped ion cell, introducing the samples obtained by laser ablation into the evacuated chamber and the trapped ion cell along a path between the magnetic poles and passing an electron beam through the trapped ion cell for ionizing the samples.

The method may further comprise the steps of: ionizing the samples obtained from laser ablation by means of inductively coupled plasma, passing a homogeneous static magnetic field through an evacuated chamber of the FT-ICR-MS containing a trapped ion cell, and injecting the ionized samples into the chamber and trapped ion cell along the magnetic field axis.

The invention thus provides a laser ablation Fourier transform ion cyclotron resonance mass spectrometer (LA-FT-ICR-MS) for trace element analysis, said spectrometer having a mass range of at least 2 to 300 amu and a mass resolution of at least 8000 for 300 amu.

The invention further provides a system for determining and quantifying specific trace elements in samples of complex materials, said system comprising a laser ablation (LA) apparatus coupled to a Fourier transform ion cyclotron resonance mass spectrometer (FT-ICR-MS) having a mass range of at least 2 to 300 amu and a mass resolution of at least 8000 for 300 amu.

Finally, the invention provides a method for determining and quantifying specific trace elements in samples of complex materials, said method comprising: sampling said material by means of laser ablation (LA) and introducing said samples into a Fourier transform ion cyclotron resonance mass spectrometer (FT-ICR-MS) having a mass range of at least 2 to 300 amu and a mass resolution of at least 8000 for 300 amu.

The application of high resolution FT-ICR mass spectrometry advantageously allows resolution of single isotopes and provides significant advantages, which enables the unimpeded specific element determination of biological, geological, and other material; this holds particularly in samples that present with high background contamination.

According to one aspect of the invention the FT-ICR-MS comprises a trapped ion cell contained within an evacuated chamber and a magnet system for providing and passing a homogeneous static magnetic field through the trapped ion cell, the samples from the laser ablation apparatus being admitted to the evacuated chamber and the trapped ion cell along a path between the magnetic poles and ionized by an electron beam passing through the trapped ion cell. Thus, ionic products from laser ablation are eliminated by the magnetic field of the FT-ICR-MS and the (neutral) element products produced by the laser ablation are directly ionized by electron ionization (EI) within the FT-ICR-MS.

Alternatively, the laser ablation apparatus is coupled to the FT-ICR-MS via a inductively coupled plasma (ICP) ion source, wherein the FT-ICR-MS comprises a trapped ion cell contained within an evacuated chamber and a magnet system for providing and passing a homogeneous static magnetic field through the trapped ion cell, the samples coming from the ICP ion source being injected into the chamber and trapped ion cell along the magnetic field axis.

### BRIEF DESCRIPTION OF THE DRAWINGS

In the following, the invention will be described in greater detail with reference to the accompanying drawing, in which

FIG. 1 shows a block diagram of an exemplary embodiment of an LA-FT-ICR-MS;

FIG. 2 is simplified diagram of an exemplary embodiment of a trapped ion cell of an FT-ICR-MS; and

FIG. 3 is a block diagram of an exemplary embodiment of an LA-ICP-FT-ICR-MS;

### DETAILED DESCRIPTION

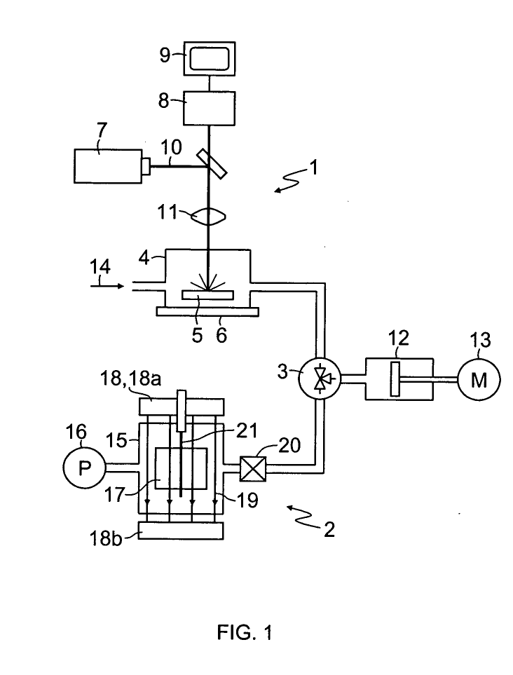

FIG. 1 shows in a schematic block diagram an exemplary embodiment of an LA-FT-ICR-MS comprising a laser ablation (LA) apparatus 1 coupled to a Fourier transform ion cyclotron resonance mass spectrometer (FT-ICR-MS) 2 via a three-way valve 3. The LA apparatus 1 comprises a sample chamber 4 containing a sample 5 of complex material, such as biological material. The sample 5 may be comprised of protein spots which have been separated by two-dimensional gel electrophoresis from cell lysate. The sample chamber 4 is mounted on a sample table 6 which is translationally moveable in x and y direction. The sample 5 is adjusted exactly by means of an adjustable laser 7 and a monitoring system comprising a camera 8 and a monitor 9. The laser 7 generates a pulsed laser beam 10 which by means of an optics system 11 is focused on selected ones of the plurality of protein spots. The sample table 6, laser 7, camera 8, monitor 9 and optics system 11 are controlled by a control computer (not shown). As a consequence of the impact of the laser beam 10, material is ablated from the surface of the sample 5 and expands into the sample chamber 4. The ablated material is ablated from the surface of the sample 5 and is transferred by a stream of inert carrier gas 12 such as argon or nitrogen stream. A syringe pump 12 which is connected to the three-way valve 3 and actuated by a stepper motor 13 draws the ablated material together with a carrier gas 14 such as argon or nitrogen from the sample chamber 4 and transfers them to the FT-ICR-MS 2 for detection of trace elements such as phosphorous, sulfur, selenium, silicon or metals in the ablated sample.

The FT-ICR-MS 2 comprises a vacuum chamber 15 which is evacuated by an appropriate pumping device 16 such as an ion pump. The vacuum chamber 15 contains a trapped ion cell 17, the function of which will be described later. The vacuum chamber 15 is situated within a permanent magnet 18 that imposes a homogeneous static magnetic field 19 over the dimension of the trapped ion cell 17. The sample to be analyzed is admitted to the vacuum chamber 15 and the trapped ion cell 17 along a path between the magnetic poles 18a, 18b by a gas phase sample introduction system 20 allowing the sample volume to be adjusted by a user or automatically adjusted. The sampled molecules are automatically converted to charged ions within the trapped ion cell 17 by a gated electron beam 21 passing through the trapped ion cell 17 in a direction parallel to the magnetic field axis.

The FT-ICR-MS 2 is preferably a SIEMENS QUANTRA-MS with a 1 T permanent magnet and providing high mass resolution of isotopes over the complete area of elemental analysis. The mass range extends at least from 2 to 300 amu with a mass resolution of at least 8000, preferably 10000, for 300 amu (the mass resolution at 2 amu is by nature higher and about 400000), thus avoiding interferences when two elements or isotopes having very similar mass.

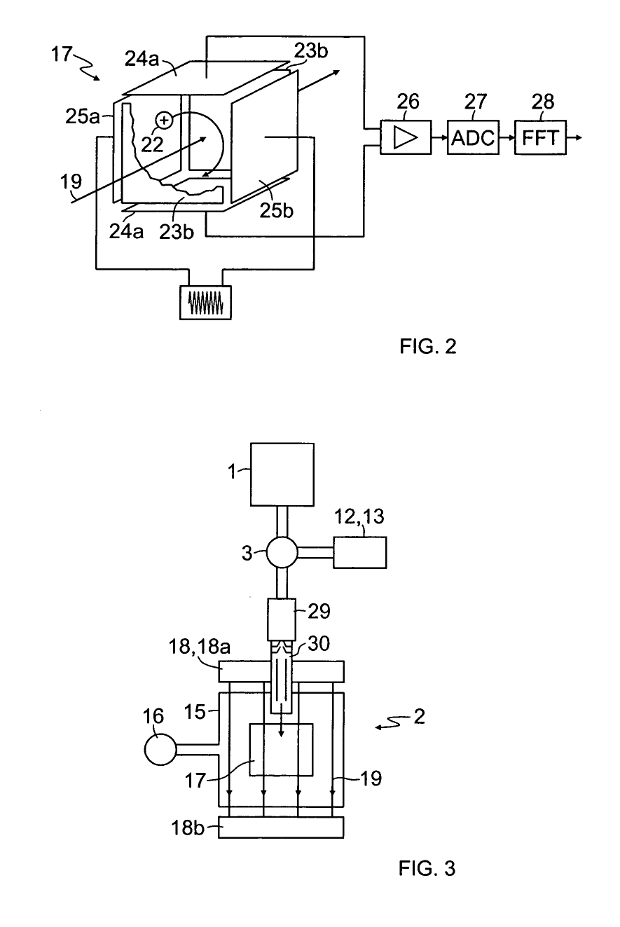

FIG. 2 is simplified diagram of an exemplary embodiment of the trapped ion cell 17, the function of which will be described in the following.

When a gas phase ion at low pressure is subjected to a uniform static magnetic field, the resulting behavior of the ion can be determined by the magnitude and orientation of the ion velocity with respect to the magnetic field. If there is a component of the ion velocity that is perpendicular to the applied field, the ion will experience a force that is perpendicular to both the velocity component and the applied field. This force results in a circular ion trajectory that is referred to as ion cyclotron motion. In the absence of any other forces on the ion, the angular frequency of this motion is a simple function of the ion charge, the ion mass, and the magnetic field strength. The function is given by ω=qB/m, wherein ω represents the angular frequency, q the ion charge, B the magnetic field strength and m the ion mass. The FT-ICR-MS can exploit this fundamental relationship to determine the mass of ions by inducing large amplitude cyclotron motion and then determining the frequency of the motion.

The ions 22 to be analyzed are first introduced to the magnetic field 19 with minimal perpendicular (radial) velocity and dispersion. The cyclotron motion induced by the magnetic field 19 can effect radial confinement of the ions 22; however, ion movement parallel to the axis of the field 19 is typically constrained by a pair of trapping electrodes 23a, 23b. These trapping electrodes 23a, 23b typically consist of a pair of parallel-plates oriented perpendicular to the magnetic axis and disposed on opposite ends of the axial dimension of initial ion population. These trapping electrodes 23a, 23b are maintained at a potential that is of the same sign as the charge of the ions 22 and of sufficient magnitude to effect axial confinement of the ions 22 between the electrode pair.

The trapped ions 22 are then exposed to an electric field that is perpendicular to the magnetic field 19 and oscillates at the cyclotron frequency of the ions 22 to be analyzed. This electric field is typically created by applying appropriate differential potentials to a second pair of parallel-plate excitation electrodes 24a, 24b oriented parallel to the magnetic axis and disposed on opposing sides of the radial dimension of the initial ion population.

If ions 22 of more than one molecular mass are to be analyzed, the frequency of the oscillating electric field is swept over an appropriate frequency range, or can be comprised of an appropriate mix of individual frequency components. When the frequency of the oscillating field matches the cyclotron frequency for a given ion mass, all of the ions 22 of that mass will experience resonant acceleration by the electric field and the radius of their cyclotron motion will increase.

During this resonant acceleration, the initial radial dispersion of the ions is essentially unchanged. The excited ions 22 will tend to remain grouped together on the circumference of the new cyclotron orbit, and to the extent that the dispersion is small relative to the new cyclotron radius, their motion will tend to be mutually in phase or coherent. If the initial ion population consisted of ions 22 of more than one molecular mass, the acceleration process can result in multiple mass ion bundles each of one mass and orbiting at its respective cyclotron frequency.

The acceleration is continued until the radius of the cyclotron orbit brings the ions 22 near enough to one or more detection electrodes 25a, 25b to result in detectable image currents being induced on the electrodes. Typically these detection electrodes 25a, 25b will consist of a third pair of parallel-plate electrodes disposed on opposing sides of the radial dimension of the initial ion population and oriented perpendicular to both the excitation electrodes 24a, 24b and trap electrodes 23a, 23b. Thus, the three pairs of parallel-plate electrodes employed for ion trapping, excitation, and detection can be mutually perpendicular and together can form a closed box-like structure referred to as the trapped ion cell 17. Other cell designs are possible, including, for example, cylindrical cells.

The image currents induced in the detection electrodes 25a, 25b are amplified (amplifier 26) and digitized (analog-to-digital converter 27). As the image currents contain frequency components from all of the mass to charge ratios of the ions, these frequencies are extracted by a Fourier transform (FFT unit 28) which converts the time-domain signal (image currents) to a frequency-domain signal (the mass spectrum).

FIG. 3 is a block diagram of an exemplary embodiment of an LA-ICP-FT-ICR-MS. In contrast to the embodiment shown in FIG. 1, the laser ablation apparatus 1 and the downstream valve 3 and syringe pump 13 are coupled to the FT-ICR-MS 2 via an inductively coupled plasma (ICP) ion source (torch) 29. Here, the sample plume is disassociated into atomic species and the atoms are ionized. The ionized samples coming from the ICP torch 29 are injected into the chamber 15 and trapped ion cell 17 of the FT-ICR-MS 2 along the magnetic field axis so that the ionized samples are not affected by the magnetic field 19. For this, the external ICP torch 29 with a quadrupole focusing unit and skimmer-aperture ion optics 30 is attached to the upper inlet system of the FT-ICR-MS 2, in exchange of the EI filament of the MS instrument shown in FIG. 1.

The mass spectrometer, system and method according to the invention are especially, but not only, useful for:
determination and quantification of phosphorous, sulfur, selenium and other relevant elements in post-translationally modified proteins and protein complexes;
specific quantifications of phosphorous, sulfur and other organic elements in proteins;
direct mass spectrometric determination and quantification of metal ions in biological samples;
quantitative element determinations in pathophysiological protein forms (e.g. in aggregate, plaque material in Alzheimer's disease);
identification and quantification of metal ions in nucleic acids (DNA; RNA) in cellular material;
element determinations as described in above in environmental and geological samples;
topological determination of elements (“element-imaging”) in biological and environmental structures, such as cell distributions; and
element determinations in topological distributions of environmental and geological microstructures

What is claimed is:

1. A laser ablation Fourier transform ion cyclotron resonance mass spectrometer (LA-FT-ICR-MS) for trace element analysis, said spectrometer having a mass range of at least 2 to 300 amu and a mass resolution of at least 8000 for 300 amu.

2. A system for determining and quantifying specific trace elements in samples of complex materials, said system comprising a laser ablation apparatus coupled to a Fourier transform ion cyclotron resonance mass spectrometer (FT-ICR-MS) having a mass range of at least 2 to 300 amu and a mass resolution of at least 8000 for 300 amu.

3. A system according to claim 2, wherein the FT-ICR-MS comprises a trapped ion cell contained within an evacuated chamber and a magnet system for providing and passing a homogeneous static magnetic field through the trapped ion cell, the samples from the laser ablation apparatus being admitted to the evacuated chamber and the trapped ion cell along a path between the magnetic poles and ionized by an electron beam passing through the trapped ion cell.

4. A system according to claim 2, wherein the laser ablation apparatus is coupled to the FT-ICR-MS via a inductively coupled plasma ion source and wherein the FT-ICR-MS comprises a trapped ion cell contained within an evacuated chamber and a magnet system for providing and passing a homogeneous static magnetic field through the trapped ion cell, the samples coming from the ICP ion source being injected into the chamber and trapped ion cell along the magnetic field axis.

5. A method for determining and quantifying specific trace elements in samples of complex materials, comprising the steps of:
sampling a material by means of laser ablation and introducing said samples into a Fourier transform ion cyclotron resonance mass spectrometer (FT-ICR-MS) having a mass range of at least 2 to 300 amu and a mass resolution of at least 8000 for 300 amu.

6. A method according to claim 5, further comprising the steps of:
passing a homogeneous static magnetic field through an evacuated chamber of the FT-ICR-MS containing a trapped ion cell,
introducing the samples obtained by laser ablation into the evacuated chamber and the trapped ion cell along a path between the magnetic poles, and
passing an electron beam through the trapped ion cell for ionizing the samples.

7. A method according to claim 5, further comprising the steps of:
ionizing the samples obtained from laser ablation by means of inductively coupled plasma,
passing a homogeneous static magnetic field through an evacuated chamber of the FT-ICR-MS containing a trapped ion cell, and
injecting the ionized samples into the chamber and trapped ion cell along the magnetic field axis.
